(19) United States
(12) Patent Application Publication
(10) Pub. No.: US 2013/0128412 A1
(43) Pub. Date: May 23, 2013

(54) ELECTRODE FOR ENERGY STORAGE AND METHOD FOR MANUFACTURING THE SAME

(71) Applicants: Jun Hee Bae, Seoul (KR); Bae Kyun Kim, Gyeonggi-do (KR); Ho Jin Yun, Gyeonggi-do (KR); Yeong Su Cho, Gyeonggi-do (KR); Chang Ryul Jung, Seoul (KR); Hak Kwan Kim, Seoul (KR)

(72) Inventors: Jun Hee Bae, Seoul (KR); Bae Kyun Kim, Gyeonggi-do (KR); Ho Jin Yun, Gyeonggi-do (KR); Yeong Su Cho, Gyeonggi-do (KR); Chang Ryul Jung, Seoul (KR); Hak Kwan Kim, Seoul (KR)

(21) Appl. No.: 13/410,169

(22) Filed: Mar. 1, 2012

(30) Foreign Application Priority Data
Nov. 22, 2011 (KR) 10-2011-0122344

(51) Int. Cl. H01G 9/155; B32B 37/12; B82Y 99/00; B82Y 40/00

(52) U.S. Cl. 361/502; 156/196; 977/734; 977/742; 977/842

(57) ABSTRACT

The present invention relates to an electrode for an energy storage and a method for manufacturing the same and provides a useful effect of improving resistance characteristics of an electrode for an energy storage and strengthening adhesion by forming trenches of predetermined dimensions on a surface of a current collector, forming a conductive layer, which includes a conductive agent as much as possible, on the surface of the current collector, and forming a bonding layer including an active material, a conductive agent, and a binder and an electrode layer including an active material and a binder on the conductive layer.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0122344, entitled filed Nov. 22, 2011, which is hereby incorporated by reference in its entirety into this application.

### BACKGROUND OF THE INVENTION

1. Field of the Invention

The present invention relates to an electrode for an energy storage and a method for manufacturing the same.

2. Description of the Related Art

Electrochemical capacitors can be classified roughly into a pseudocapacitor and an electric double layer capacitor (EDLC).

The pseudocapacitor uses a metal oxide as an electrode active material, and development of capacitors using a metal oxide has been continuously made for the past 20 years.

Meanwhile, most studies of the pseudocapacitor use a ruthenium oxide, an iridium oxide, a tantalum oxide, and a vanadium oxide.

The pseudocapacitor has a disadvantage that utilization of the electrode active material is reduced due to non-uniformity of potential distribution of a metal oxide electrode.

In case of the EDLC, currently, a porous carbon material with high electrical conductivity, high thermal conductivity, low density, suitable corrosion resistance, low coefficient of thermal expansion, and high purity is used as an electrode active material. However, in order to improve performance of the capacitor, many studies have been made on preparation of a new electrode active material, surface modification of the electrode active material, performance improvement of a separator and an electrolyte, and performance improvement of an organic solvent electrolyte for increasing utilization and cycle life of the electrode active material and improving high rate charging and discharging characteristics.

In case of a currently studied capacitor, a current collector made of an aluminum or titanium sheet or an expanded aluminum or titanium sheet is mainly used as current collectors of both electrodes and in addition, various types of current collectors such as a punched aluminum or titanium sheet are used.

However, this current collector has relatively high contact resistance with an electrode active material due to an oxide layer naturally formed on a surface thereof. Due to this, there are limits to charging and discharging characteristics and cycle life.

Since there is an increasing demand of industry for high voltage and high rate charging and discharging characteristics, it is necessary to improve these characteristics.

FIG. 1 is a view schematically illustrating a typical electrode structure of the prior art.

Referring to FIG. 1, generally, a current collector is implemented with an aluminum foil with a thickness of 20 to 30 μm, and at this time, a surface of the aluminum foil is etched with acid to form a trench with a thickness of 2 to 5 μm.

When the surface of the current collector is treated like this, since a surface area of the current collector 20 is increased, it causes an increase in effective contact area between the current collector 20 and an electrode active material 10 and a reduction in contact resistance between the current collector 20 and the electrode active material 10.

However, actually, when magnifying and looking into a boundary between the electrode and the current collector through an electron microscope, it is possible to check that the electrode active material is not in complete contact with the current collector 20 along the trench and there is an empty space 22.

That is, although it looks to the naked eye that the current collector and the electrode active material are well bonded to each other, actually, there are many non-contact portions and thus contact resistance is increased.

A cause of this non-contact region is that an average particle diameter of activated carbon powder, an electrode active material mainly used at this time, is 5 to 10 μm, which is greater than an average width of the trench, that is, about 1 to 2 μm.

As current and voltage applied to the current collector are increased, the contact resistance increased due to the non-contact region causes greater performance degradation.

Meanwhile, Patent Document 1 discloses a technology that an electrical conductive layer is provided between a capacitance enhancing layer and a current collector to overcome this problem.

The electrical conductive layer used in the Patent Document 1 should include a binder of more than 10 wt % to satisfy adhesion with the current collector. It is because the current collector and the electrical conductive layer are easily separated from each other and thus reliability is reduced when the binder content is reduced.

However, when the binder content is high like the technology disclosed in the Patent Document 1, the conductive agent content should be reduced. That is, since the conductive agent content in the electrical conductive layer in accordance with the Patent Document 1 can not be more than 90 wt %, there is a limit in reducing resistance.

### RELATED PRIOR ART DOCUMENT

Patent Document 1: Korean Patent Laid-open Publication No. 10-2004-0101643

### SUMMARY OF THE INVENTION

The present invention has been invented in order to overcome the above-described problems and it is, therefore, an object of the present invention to provide an electrode for an energy storage having a conductive layer between a current collector and an electrode layer while providing a bonding layer between the conductive layer and the electrode layer to strengthen adhesion between the conductive layer and the electrode layer, and a method for manufacturing the same.

In accordance with one aspect of the present invention to achieve the object, there is provided an electrode for an energy storage including: a current collector having a plurality of trenches formed on a surface thereof; a conductive layer formed by bonding a material including a conductive agent and a binder to the surface of the current collector; a bonding layer formed by bonding a material including a conductive agent, an active material, and a binder to a surface of the conductive layer; and an electrode layer formed by bonding a material including an active material and a binder to the surface of the bonding layer, wherein a weight ratio of the conductive agent included in the bonding layer is lower than that of the conductive agent included in the conductive layer, a weight ratio of the active material included in the bonding layer is lower than that of the active material included in the electrode layer, and a ratio of horizontal cross section to depth of the trench is 1:3.

At this time, an average horizontal cross section of the trench is 0.5 to 1 μm, and a particle diameter of the conductive agent and the binder is 50 to 300 nm.

And, the bonding layer consists of a plurality of bonding layers.

Further, a sum of the weight ratio of the active material and the weight ratio of the conductive agent included in each of the plurality of bonding layers is more than 90 wt %.

Further, the weight ratio of the active material and the weight ratio of the conductive agent included in each of the plurality of bonding layers are different from each other.

Further, the plurality of bonding layers consist of a first bonding layer in which the weight of the conductive agent is three times the weight of the active material; a second bonding layer in which the weight of the conductive agent is one times the weight of the active material and which is bonded to an upper portion of the first bonding layer; and a third bonding layer in which the weight of the conductive agent is one third times the weight of the active material and which is bonded to an upper portion of the second bonding layer.

Further, a thickness of each bonding layer is 1 to 10 μm.

Further, the weight ratio of the conductive agent in the conductive layer exceeds 90 wt %.

Further, the active material is at least one material or a mixture of at least two materials selected from activated carbon, graphene, carbon nanotube (CNT), and carbon nanofiber (CNF).

Further, the conductive agent is at least one material or a mixture of at least two materials selected from graphite, cokes, activated carbon, carbon black, carbon nanotube (CNT), and graphene.

Further, the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

Further, the active material is at least one material or a mixture of at least two materials selected from activated carbon, graphene, carbon nanotube (CNT), and carbon nanofiber (CNF), the conductive agent is at least one material or a mixture of at least two materials selected from graphite, cokes, activated carbon, carbon black, carbon nanotube (CNT), and graphene, and the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

Meanwhile, in accordance with another aspect of the present invention to achieve the object, there is provided a method for manufacturing an electrode for an energy storage including: (a) forming a plurality of trenches on a surface of a current collector; (b) applying conductive slurry including a conductive agent and a binder on the surface of the current collector; (c) forming a conductive layer by pressing the conductive slurry in the direction of a surface bonded to the current collector; (d) applying bonding slurry including a conductive agent, an active material, and a binder on a surface of the conductive layer; (e) forming a bonding layer by pressing the bonding slurry in the direction of a surface bonded to the conductive layer; and (f) forming an electrode layer by applying electrode slurry including an active material and a binder on a surface of the bonding layer, wherein a weight ratio of the conductive agent included in the bonding slurry is lower than that of the conductive agent included in the conductive slurry, a weight ratio of the active material included in the bonding slurry is lower than that of the active material included in the electrode slurry, and a ratio of horizontal cross section to depth of the trench is 1:3.

At this time, the step of forming the trench performs treatment for several seconds to tens of minutes using at least one material selected from the group consisting of hydrochloric acid, phosphoric acid, fluosilicic acid, and sulfuric acid.

And, after the step (e), a plurality of bonding layers are formed by sequentially repeating (g) applying the bonding slurry including an active material, a conductive agent, and a binder on the surface of the bonding layer; and (h) forming the bonding layer by pressing the bonding slurry of the step (g) in the direction of a surface bonded to the bonding layer, wherein the weight ratio of the conductive agent included in the bonding slurry of the step (g) is lower than that of the conductive agent included in the conductive slurry, and the weight ratio of the active material included in the bonding slurry is lower than that of the active material included in the electrode slurry.

Further, a sum of the weight ratio of the active material and the weight ratio of the conductive agent included in each of the plurality of bonding layers formed by the steps (e) and (h) is more than 90 wt %.

Further, the weight ratio of the active material and the weight ratio of the conductive agent included in each of the plurality of bonding layers formed by the steps (e) and (h) are different from each other.

Further, the plurality of bonding layers consist of a first bonding layer in which the weight of the conductive agent is three times the weight of the active material; a second bonding layer in which the weight of the conductive agent is one times the weight of the active material and which is bonded to an upper portion of the first bonding layer; and a third bonding layer in which the weight of the conductive agent is one third times the weight of the active material and which is bonded to an upper portion of the second bonding layer.

Further, a thickness of each bonding layer is 1 to 10 μm.

Further, the step of forming the conductive layer is performed by a hot roll press method.

Further, the weight ratio of the conductive agent in the conductive slurry exceeds 90 wt %.

Further, the conductive agent is at least one material or a mixture of at least two materials selected from graphite, cokes, activated carbon, carbon black, carbon nanotube (CNT), and graphene.

Further, the active material is at least one material or a mixture of at least two materials selected from activated carbon, graphene, carbon nanotube (CNT), and carbon nanofiber (CNF).

Further, the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

Further, the active material is at least one material or a mixture of at least two materials selected from activated carbon, graphene, carbon nanotube (CNT), and carbon nanofiber (CNF), the conductive agent is at least one material or a mixture of at least two materials selected from graphite, cokes, activated carbon, carbon black, carbon nanotube (CNT), and graphene, and the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically illustrating a typical electrode structure of the prior art;

FIG. 2 is a cross-sectional view schematically illustrating an electrode structure in accordance with an embodiment of the present invention;

FIG. 3 is a view for explaining conditions of a trench in accordance with an embodiment of the present invention; and

FIG. 4 is a cross-sectional view specifically showing a bonding layer in accordance with an embodiment of the present invention.

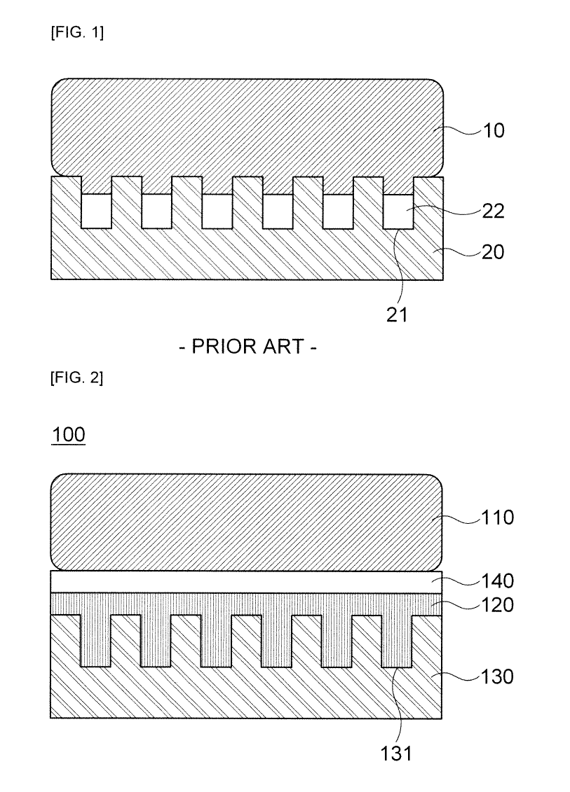

### DETAILED DESCRIPTION OF THE PREFERABLE EMBODIMENT

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. Further, terms “comprises” and/or “comprising” used herein specify the existence of described components, steps, operations, and/or elements, but do not preclude the existence or addition of one or more other components, steps, operations, and/or elements.

Hereinafter, configuration and operational effect of the present invention will be described in detail with reference to the accompanying drawings.

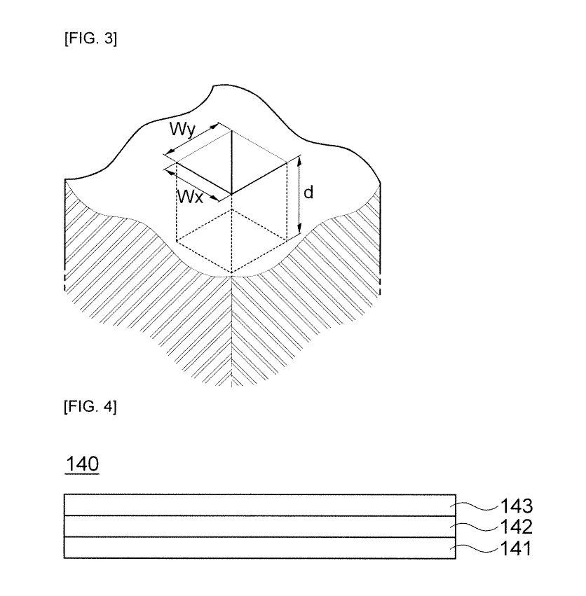

FIG. 2 is a cross-sectional view schematically illustrating an electrode structure in accordance with an embodiment of the present invention, and FIG. 3 is a view for explaining conditions of a trench 131 in accordance with an embodiment of the present invention.

Referring to FIGS. 2 and 3, an electrode for an energy storage in accordance with an embodiment of the present invention may include a current collector 130 having trenches 131, a conductive layer 120, a bonding layer 140, and an electrode layer 110.

The current collector 130 may be implemented with an aluminum or titanium sheet or an expanded aluminum or titanium sheet.

A plurality of trenches 131 are formed on a surface of the current collector 130.

The trench 131 performs a role of improving adhesion between the current collector 130 and the conductive layer 120 by increasing a specific surface area of the current collector 130.

At this time, it is preferred that the trench 131 is formed at a ratio of horizontal cross section to depth of 1:3.

When the depth is too large compared to the horizontal cross section, there are problems with uniformity and density in the overall formation of the trench 131 and disconnection of the current collector 130 due to a reduction in strength of the current collector 130 in a process of manufacturing a cell of an electrochemical capacitor. Further, there is a limit in increasing an actual effective contact area with the conductive layer 120.

On the contrary, when the depth is too small compared to the horizontal cross section, there is a problem that it is difficult to obtain an effect due to an increase in the contact area compared to an existing current collector.

The conductive layer 120 may include a conductive agent with high electrical conductivity.

At this time, the conductive agent may be at least one material selected from graphite, cokes, activated carbon, carbon black, carbon nanotube (CNT), and graphene.

Meanwhile, the conductive layer 120 includes a binder for adhesion between the conductive agents, between the conductive layer 120 and the current collector 130, and between the conductive layer 120 and the bonding layer 140.

The binder may be at least one material selected from fluorine resins such as polytetrafluoroethylene (PTFE) and polyvinylidenfluoride (PVDF); thermoplastic resins such as polyimide, polyamideimide, polyethylene (PE), and polypropylene (PP); and cellulose resins such as carboxymethyl cellulose (CMC); rubber resins such as styrene-butadiene rubber (SBR); and mixtures thereof.

Meanwhile, it is preferred that an average horizontal cross section of the trench 131 is 0.5 to 1 μm and a particle diameter of the conductive agent and the binder is 50 to 300 nm.

The reason is because the conductive agent should be filled in the trench 131 without empty space. If the particle diameter is larger than the cross section of the trench 131, since the empty space inside the trench is not completely filled, resistance is increased.

Further, since the conductive agent constituting the conductive layer 120 is densely introduced inside the trench 131 so that the conductive layer 120 and the current collector 130 are closely bonded to each other, the adhesion between the conductive layer 120 and the current collector 130 is increased.

Accordingly, although the binder content of the conductive layer 120 is less than 10 wt %, the adhesion between the conductive layer 120 and the current collector 130 is sufficiently secured, and since the binder content is reduced, electrical conductivity is also improved than before.

The electrode layer 110 is made of an active material and may be bonded to a surface of the bonding layer 140. Further, as described above, the bonding layer 140 may include the binder for adhesion between the active materials and between the bonding layer 140 and the electrode layer 110.

The active material is at least one material or a mixture of at least two materials selected from activated carbon, graphene, carbon nanotube (CNT), and carbon nanofiber (CNF).

The bonding layer 140 includes a conductive agent and an active material and may be bonded to a surface of the conductive layer 120. Further, as described above, the bonding layer 140 may include a binder for the adhesion between the conductive agents, between the active materials, between the bonding layer 140 and the conductive layer 120, and between the bonding layer 140 and the electrode layer 110.

At this time, a weight ratio of the conductive agent included in the bonding layer 140 is lower than that of the conductive agent included in the conductive layer 120, and a weight ratio of the active material included in the bonding layer 140 is lower than that of the active material included in the electrode layer 110. The reason to set the weight ratios like this will be described below.

And, it is preferred that a sum of the weight ratio of the active material and the weight ratio of the conductive agent included in the bonding layer 140 is more than 90 wt %. That is, it is to allow the binder only to function as the minimum bonding agent and to improve characteristics of the bonding layer by increasing the weight ratios of the active material and the conductive agent.

FIG. 4 is a cross-sectional view specifically showing the bonding layer 140 in accordance with an embodiment of the present invention.

Referring to FIG. 4, the bonding layer 140 may consist of a plurality of bonding layers. The weight ratios of the active material and the conductive agent included in the respective bonding layers may be different from each other.

Specifically, the plurality of bonding layers 140 consist of a first bonding layer 141 in which the weight of the conductive agent is three times the weight of the active material; a second bonding layer 142 in which the weight of the conductive agent is one times the weight of the active material and which is bonded to an upper portion of the first bonding layer 141; and a third bonding layer 143 in which the weight of the conductive agent is one third times the weight of the active material and which is bonded to an upper portion of the second bonding layer 142.

Like this, the electrode 100 for an energy storage in accordance with an embodiment of the present invention can strengthen the adhesion between the conductive layer 120 and the electrode layer 110 by providing the plurality of bonding layers 140, in which the weight ratios of the active material and the conductive agent are gradually mixed, between the conductive layer 120 and the electrode layer 110.

The reason is because it is possible to secure structural stability by overcoming boundary delaminating due to a difference in thermal residual stress occurring in the bonding boundary when dissimilar materials with different physical and chemical properties, here, the conductive agent constituting the conductive layer 120 and the active material constituting the electrode layer 110, are directly bonded to each other by providing the plurality of bonding layers 140, in which the weight ratios of the active material and the conductive agent are gradually mixed, between the conductive layer 120 and the electrode layer 110 to minimize the difference in thermal residual stress.

Meanwhile, when a thickness of each bonding layer 140 is large, mechanical strength may be reduced, and when the thickness of each bonding layer 140 is too small, the difference in residual stress can't be minimized. Therefore, it is preferred that the thickness of each bonding layer 140 is 1 to 10 μm.

Meanwhile, a method for manufacturing an electrode 100 for an energy storage in accordance with an embodiment of the present invention may include the steps of forming a plurality of trenches 131 on a surface of a current collector 130; applying conductive slurry including a conductive agent and a binder on the surface of the current collector 130; forming a conductive layer 120 by pressing the conductive slurry in the direction of a surface bonded to the current collector 130; applying bonding slurry including an active material, a conductive agent, and a binder on a surface of the conductive layer 120; forming a bonding layer 140 by pressing the bonding slurry to a surface bonded to the conductive layer 120; and forming an electrode layer 110 by applying electrode slurry including an electrode active material and a binder on a surface of the bonding layer 140.

First, the plurality of trenches 131 are formed by treating the surface of the current collector 130.

At this time, the surface of the current collector 130 is treated for several seconds to tens of minutes with at least one material selected from the group consisting of hydrochloric acid, phosphoric acid, fluosilicic acid, and sulfuric acid.

As a result of this treatment, the trench 131 is formed at a ratio of horizontal cross section to depth of 1:3.

Further, an average horizontal cross section of the trench 131 is 0.5 to 1 μm.

Next, the conductive slurry including a conductive agent and a binder is applied on the surface of the current collector 130.

At this time, it is preferable to prepare the conductive slurry so that the binder content exceeds 90 wt % to maximize resistance characteristics.

Further, as described above, since an average horizontal cross section of the trench 131 is 0.5 to 1 μm, in preparing the conductive slurry, it is preferable to use a conductive agent and a binder with a particle diameter of 50 to 300 nm. The reason is the same as described above and thus repeated description will be omitted.

Next, the conductive layer 120 is formed by pressing the conductive slurry in the direction of the surface bonded to the current collector 130.

At this time, a hot roll press method may be applied, and accordingly, the conductive slurry is deeply introduced into the trenches 131 so that the conductive layer 120 is formed. Due to this, contact resistance between the conductive layer 120 and the current collector 130 may be minimized.

Next, the bonding layer 140 is formed by applying the bonding slurry including an active material, a conductive agent, and a binder on the surface of the conductive layer 120 and pressing the bonding slurry in the direction of the surface bonded to the conductive layer 120. At this time, a weight ratio of the conductive agent included in the bonding slurry may be set to lower than that of the conductive agent included in the conductive slurry, and a weight ratio of the active material included in the bonding slurry is set to lower than that of the active material included in the electrode slurry.

Meanwhile, a plurality of bonding layers 140 are formed by repeating the step of forming the bonding layer 140 several times. For example, a first bonding layer 141 is formed by applying the bonding slurry including an active material, a conductive agent, and a binder on the surface of the conductive layer and pressing the bonding slurry in the direction of the surface bonded to the conductive layer. After that, a second bonding layer 142 is formed by applying the bonding slurry including an active material, a conductive agent, and a binder on a surface of the first bonding layer 141 and pressing the bonding slurry in the direction of the surface bonded to the first bonding layer 141 again. After that, a third bonding layer 143 is formed by applying the bonding slurry including an active material, a conductive agent, and a binder on a surface of the second bonding layer 142 and pressing the bonding slurry in the direction of the surface bonded to the first bonding layer 142 again. The plurality of bonding layers 140 are formed by repeating this process several times.

At this time, the weight ratios of the active material and the conductive agent included in the respective bonding layers 140 may be configured to be different from each other.

Specifically, the plurality of bonding layers 140 consist of the first bonding layer 141 in which the weight of the conductive agent is three times the weight of the active material, the second bonding layer 142 in which the weight of the conductive agent is one times the weight of the active material and which is bonded to an upper portion of the first bonding layer, and the third bonding layer 143 in which the weight of the conductive agent is one third times the weight of the active material and which is bonded to an upper portion of the second bonding layer.

Meanwhile, for the same reason as described above, it is preferred that a thickness of each bonding layer 140 is 1 to 10 μm.

The electrode for an energy storage in accordance with an embodiment of the present invention configured as above provides a useful effect of improving resistance characteristics by minimizing use of a binder while preventing deterioration of the adhesion between the current collector, the conductive layer, and the electrode layer.

Further, the electrode for an energy storage in accordance with an embodiment of the present invention configured as above provides a useful effect of improving resistance characteristics of an electrode for an energy storage compared to the prior art by optimizing dimensions of the trench and the particle diameter of the conductive agent and the binder to minimize the binder content.

Further, the electrode for an energy storage in accordance with an embodiment of the present invention configured as above provides a useful effect of strengthening the adhesion between the conductive layer and the electrode layer, which are made of different materials, by providing the bonding layer between the conductive layer and the electrode layer.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. An electrode for an energy storage comprising:
a current collector having a plurality of trenches formed on a surface thereof;
a conductive layer formed by bonding a material including a conductive agent and a binder to the surface of the current collector;
a bonding layer formed by bonding a material including a conductive agent, an active material, and a binder to a surface of the conductive layer; and
an electrode layer formed by bonding a material including an active material and a binder to a surface of the bonding layer, wherein a weight ratio of the conductive agent included in the bonding layer is lower than that of the conductive agent included in the conductive layer, a weight ratio of the active material included in the bonding layer is lower than that of the active material included in the electrode layer, and a ratio of horizontal cross section to depth of the trench is 1:3.

2. The electrode for an energy storage according to claim 1, wherein an average horizontal cross section of the trench is 0.5 to 1 μm, and a particle diameter of the conductive agent and the binder is 50 to 300 nm.

3. The electrode for an energy storage according to claim 1, wherein the bonding layer consists of a plurality of bonding layers.

4. The electrode for an energy storage according to claim 3, wherein a sum of the weight ratio of the active material and the weight ratio of the conductive agent included in each of the plurality of bonding layers is more than 90 wt %.

5. The electrode for an energy storage according to claim 4, wherein the weight ratio of the active material and the weight ratio of the conductive agent included in each of the plurality of bonding layers are different from each other.

6. The electrode for an energy storage according to claim 5, wherein the plurality of bonding layers consist of:
a first bonding layer in which the weight of the conductive agent is three times the weight of the active material;
a second bonding layer in which the weight of the conductive agent is one times the weight of the active material and which is bonded to an upper portion of the first bonding layer; and
a third bonding layer in which the weight of the conductive agent is one third times the weight of the active material and which is bonded to an upper portion of the second bonding layer.

7. The electrode for an energy storage according to claim 6, wherein a thickness of each bonding layer is 1 to 10 μm.

8. The electrode for an energy storage according to claim 1, wherein the weight ratio of the conductive agent in the conductive layer exceeds 90 wt %.

9. The electrode for an energy storage according to claim 1, wherein the active material is at least one material or a mixture of at least two materials selected from activated carbon, graphene, carbon nanotube (CNT), and carbon nanofiber (CNF).

10. The electrode for an energy storage according to claim 1, wherein the conductive agent is at least one material or a mixture of at least two materials selected from graphite, cokes, activated carbon, carbon black, carbon nanotube (CNT), and graphene.

11. The electrode for an energy storage according to claim 1, wherein the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

12. The electrode for an energy storage according to claim 1, wherein the active material is at least one material or a mixture of at least two materials selected from activated carbon, graphene, carbon nanotube (CNT), and carbon nanofiber (CNF),
the conductive agent is at least one material or a mixture of at least two materials selected from graphite, cokes, activated carbon, carbon black, carbon nanotube (CNT), and graphene, and
the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

13. A method for manufacturing an electrode for an energy storage comprising:
(a) forming a plurality of trenches on a surface of a current collector;
(b) applying conductive slurry including a conductive agent and a binder on the surface of the current collector;
(c) forming a conductive layer by pressing the conductive slurry in the direction of a surface bonded to the current collector;
(d) applying bonding slurry including a conductive agent, an active material, and a binder on a surface of the conductive layer;
(e) forming a bonding layer by pressing the bonding slurry in the direction of a surface bonded to the conductive layer; and
(f) forming an electrode layer by applying electrode slurry including an active material and a binder on a surface of the bonding layer, wherein a weight ratio of the conductive agent included in the bonding slurry is lower than that of the conductive agent included in the conductive slurry, a weight ratio of the active material included in the bonding slurry is lower than that of the active material included in the electrode slurry, and a ratio of horizontal cross section to depth of the trench is 1:3.

14. The method for manufacturing an electrode for an energy storage according to claim 13, wherein forming the trench performs treatment for several seconds to tens of minutes using at least one material selected from the group consisting of hydrochloric acid, phosphoric acid, fluosilicic acid, and sulfuric acid.

15. The method for manufacturing an electrode for an energy storage according to claim 13, wherein after the step (e), a plurality of bonding layers are formed by sequentially repeating (g) applying the bonding slurry including an active material, a conductive agent, and a binder on the surface of the bonding layer; and (h) forming the bonding layer by pressing the bonding slurry of the step (g) in the direction of a surface bonded to the bonding layer, wherein the weight ratio of the conductive agent included in the bonding slurry of the step (g) is lower than that of the conductive agent included in the conductive slurry, and the weight ratio of the active material included in the bonding slurry is lower than that of the active material included in the electrode slurry.

16. The method for manufacturing an electrode for an energy storage according to claim 15, wherein a sum of the weight ratio of the active material and the weight ratio of the conductive agent included in each of the plurality of bonding layers formed by the steps (e) and (h) is more than 90 wt %.

17. The method for manufacturing an electrode for an energy storage according to claim 16, wherein the weight ratio of the active material and the weight ratio of the conductive agent included in each of the plurality of bonding layers formed by the steps (e) and (h) are different from each other.

18. The method for manufacturing an electrode for an energy storage according to claim 17, wherein the plurality of bonding layers consist of:
a first bonding layer in which the weight of the conductive agent is three times the weight of the active material;
a second bonding layer in which the weight of the conductive agent is one times the weight of the active material and which is bonded to an upper portion of the first bonding layer; and
a third bonding layer in which the weight of the conductive agent is one third times the weight of the active material and which is bonded to an upper portion of the second bonding layer.

19. The method for manufacturing an electrode for an energy storage according to claim 18, wherein a thickness of each bonding layer is 1 to 10 μm.

20. The method for manufacturing an electrode for an energy storage according to claim 13, wherein forming the conductive layer is performed by a hot roll press method.

21. The method for manufacturing an electrode for an energy storage according to claim 13, wherein the weight ratio of the conductive agent in the conductive slurry exceeds 90 wt %.

22. The method for manufacturing an electrode for an energy storage according to claim 13, wherein the conductive agent is at least one material or a mixture of at least two materials selected from graphite, cokes, activated carbon, carbon black, carbon nanotube (CNT), and graphene.

23. The method for manufacturing an electrode for an energy storage according to claim 13, wherein the active material is at least one material or a mixture of at least two materials selected from activated carbon, graphene, carbon nanotube (CNT), and carbon nanofiber (CNF).

24. The method for manufacturing an electrode for an energy storage according to claim 13, wherein the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.

25. The method for manufacturing an electrode for an energy storage according to claim 13, wherein the active material is at least one material or a mixture of at least two materials selected from activated carbon, graphene, carbon nanotube (CNT), and carbon nanofiber (CNF),
the conductive agent is at least one material or a mixture of at least two materials selected from graphite, cokes, activated carbon, carbon black, carbon nanotube (CNT), and graphene, and
the binder is at least one material or a mixture of at least two materials selected from polytetrafluoroethylene, polyvinylidenfluoride, polyimide, polyamideimide, polyethylene, polypropylene, carboxymethyl cellulose, and styrene-butadiene rubber.
